(19) United States
(12) Patent Application Publication
(10) Pub. No.: US 2022/0236717 A1
(43) Pub. Date: Jul. 28, 2022

(54) DRIVE-THROUGH TRANSACTION SYSTEM

(71) Applicant: Wilmith Augustin, Kissimmee, FL (US)

(72) Inventor: Wilmith Augustin, Kissimmee, FL (US)

(21) Appl. No.: 17/156,873

(22) Filed: Jan. 25, 2021

(51) Int. Cl. G05B 19/4155; G07G 1/00

(52) U.S. Cl. CPC G05B 19/4155; G05B 2219/45054; G07G 1/0027

(57) ABSTRACT

A drive-through transaction system disposed within a drive-through window, the drive-through transaction system including a drawer assembly, including a drawer body, a tray movably disposed within at least a portion of the drawer body to receive at least one item thereon, and a plurality of cup holders disposed on and within at least a portion of the tray to receive at least one beverage cup therein, and a transaction device connected to the drawer assembly to receive input of an order and display a price of the order, such that the drawer body is ejected from the drive-through window in response to completion of the order.

### BACKGROUND

### 1. Field

The present general inventive concept relates generally to a transaction system, and particularly, to a drive-through transaction system.

### 2. Description of the Related Art

Drive-through services allow customers to remain in their vehicles while performing a transaction at a facility, such as purchasing food. However, the wait time at a drive-through window is frequently long. Generally, delays occur during a monetary exchange between an employee of the facility and a customer.

Moreover, the monetary exchange and/or an exchange of goods requires a certain level of physical interaction between the customer and the employee. In recent times, it is well known that physical interaction significantly increases the probability of disease transmission.

Therefore, there is a need for a drive-through transaction system that minimizes physical interaction.

### SUMMARY

The present general inventive concept provides a drive-through transaction system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a drive-through transaction system disposed within a drive-through window, the drive-through transaction system including a drawer assembly, including a drawer body, a tray movably disposed within at least a portion of the drawer body to receive at least one item thereon, and a plurality of cup holders disposed on and within at least a portion of the tray to receive at least one beverage cup therein, and a transaction device connected to the drawer assembly to receive input of an order and display a price of the order, such that the drawer body is ejected from the drive-through window in response to completion of the order.

The tray may separate a first portion of the drawer body from a second portion of the drawer body.

The drawer assembly may further include a hydraulic piston disposed on at least a portion of a base of the drawer body and connected to at least a portion of a bottom surface of the tray to adjust a height of the tray.

The drawer assembly may further include a barrier movably disposed on at least a portion of the drawer body to prevent access within the drawer body in a first position and allow access within the drawer body in a second position, and a barrier handle disposed on at least a portion of an outer surface of the barrier to facilitate gripping thereof.

The drive-through transaction system may further include a sanitization device disposed on at least a portion of the drawer assembly and the transaction device to decontaminate the barrier and the barrier handle.

The transaction device may include a main body, a display unit disposed on at least a portion of the main body to display the order thereon, a payment receiving section disposed on at least a portion of the main body to receive at least one of a payment card, at least one paper bill, at least one coin, and an electronic wallet signal therein, and a change dispenser disposed on at least a portion of the main body to dispense a difference in money owed as received by the payment receiving section.

The drive-through transaction system may further include a heating unit disposed within at least a portion of the drawer body to increase a temperature level within the drawer body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of a drive-through transaction system with a drawer assembly in an opened position, according to an exemplary embodiment of the present general inventive concept; and

FIG. 2 illustrates a front perspective view of the drive-through transaction system with the drawer assembly in a closed position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Drive-Through Transaction System 100
Drawer Assembly 110
Drawer Body 111
Tray 112
Tray Handle 112a
Cup Holders 113
Hydraulic Piston 114
Barrier 115
Barrier Handle 115a
Tracks 116
Retraction Button 117
Drawer Handle 118
Transaction Device 120
Main Body 121
Display Unit 122
Control Unit 122a
Payment Receiving Section 123
Card Slot 123a
Paper Bill Slot 123b
Coin Slot 123c
Contactless Receiver 123d
Change Dispenser 124
Receipt Dispenser 125
Receipt Container 125a
Audio Unit 126
Input Ports 127
Power Source 128
Access Barrier 129
Sanitization Device 130
Heating Unit 140

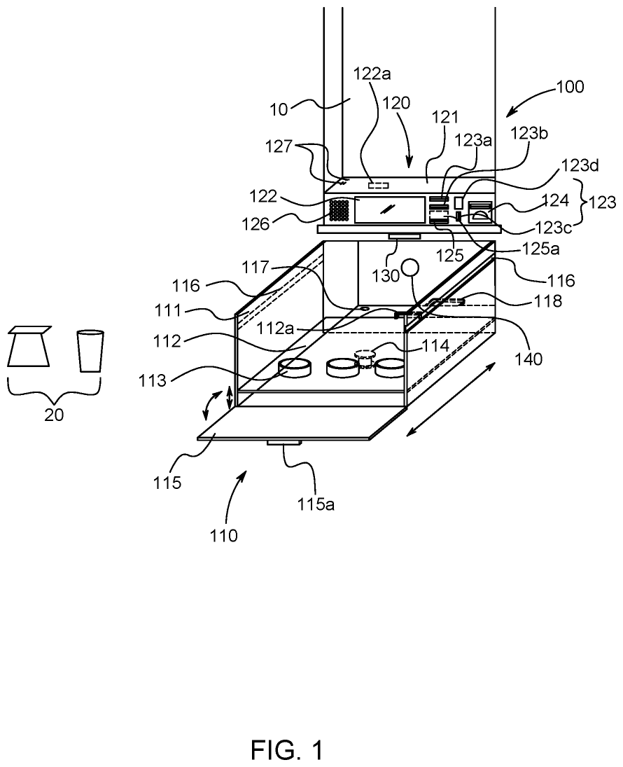

FIG. 1 illustrates a front perspective view of a drive-through transaction system 100 with a drawer assembly 110 in an opened position, according to an exemplary embodiment of the present general inventive concept.

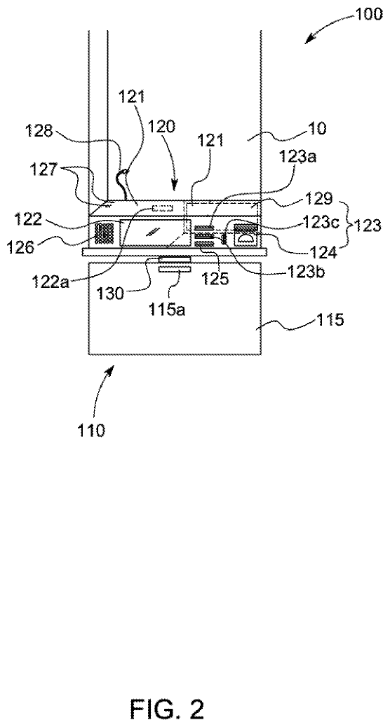

FIG. 2 illustrates a front perspective view of the drive-through transaction system 100 with the drawer assembly 110 in a closed position, according to an exemplary embodiment of the present general inventive concept.

The drive-through transaction system 100 may be constructed from at least one of metal, plastic, wood, ceramic, glass, and rubber, etc., but is not limited thereto.

The drive-through transaction system 100 may include a drawer assembly 110, a transaction device 120, a sanitization device 130, and a heating unit 140, but is not limited thereto.

The drawer assembly 110 may include a drawer body 111, a tray 112, a plurality of cup holders 113, a hydraulic piston 114, a barrier 115, a plurality of tracks 116, a retraction button 117, and a drawer handle 118, but is not limited thereto.

Referring to FIGS. 1 and 2, the drawer body 111 is illustrated to have a rectangular prism shape. However, the drawer body 111 may be rectangular, circular, conical, triangular, pentagonal, hexagonal, heptagonal, octagonal, or any other shape known to one of ordinary skill in the art, but is not limited thereto.

The drawer body 111 may be removably and/or movably (i.e. slidably) connected within a drive-through window 10. Moreover, the drawer body 111 may store at least one item 20 therein, such as a beverage cup, a container of food, and/or money.

The tray handle 112 may include a tray handle 112a, but is not limited thereto.

The tray 112 may be removably and/or movably (i.e. slidably) disposed within at least a portion of the drawer body 111. Moreover, the tray 112 may separate a first portion of the drawer body 111 from a second portion of the drawer body 111. The tray 112 may be a planar surface, such that the tray 112 may receive the at least one item 20 thereon.

The tray handle 112a may be disposed on at least a portion of an edge of the tray 112. The tray handle 112a may facilitate gripping thereof. As such, the tray 112 may move in a vertical and/or a lateral direction in response to movement of the tray handle 112a, such as pushing and/or pulling thereof by a user.

The plurality of cup holders 113 may be disposed on and/or within at least a portion of the tray 112. More specifically, the plurality of cup holders 113 may protrude away from a first side of the tray 112 with respect to a first direction and/or a second side of the tray 112 with respect to a second direction opposite with respect to the first direction. In other words, the plurality of cup holders 113 may stick out from two sides of the tray 112. Additionally, each of the plurality of cup holders 113 may be a same size (i.e. height, width, diameter) and/or a different size, depending on a preference of an owner and/or a manufacturer. Also, the plurality of cup holders 113 may store the at least one item 20 therein, such as the beverage cup. Furthermore, the plurality of cup holders 113 may store the at least one item 20 at a plurality of different planes (e.g., lower plane, higher plane) with respect to the tray 112, such that the at least one item 20 protrudes away from the tray 112.

The hydraulic piston 114 may be disposed on at least a portion of a base of the drawer body 111 and connected to at least a portion of a bottom surface of the tray 112. The hydraulic piston 114 may adjust a height of the tray 112 within the drawer body 111. In other words, the height of the tray 112 may adjust in response to movement of the hydraulic piston 114. As such, the height of the tray 112 may adjust based on the preference of the user.

The barrier 115 may include a barrier handle 115a, but is not limited thereto.

The barrier 115 may be movably (i.e. pivotally and/or hingedly) disposed on at least a portion of a first end of the drawer body 111. Referring to FIGS. 1 and 2, the barrier 115 may move from closed in a first position to at least partially opened in a second position. Conversely, the barrier 115 may move from opened in the second position to closed in the first position. As such, the barrier 115 may allow access within the drawer body 111 in the second position and prevent access within the drawer body 111 in the first position.

The barrier handle 115a may be disposed on at least a portion of an outer surface of the barrier 115. The barrier handle 115a may facilitate gripping thereof. As such, the barrier 115 may move in response to movement of the barrier handle 115a, such as pushing and/or pulling thereof by the user.

The plurality of tracks 116 may be disposed on at least a portion of a first side of the drawer body 111 and a second side of the drawer body 111, such that the second side of the drawer body 111 is distanced from the first side of the drawer body 111. Moreover, the plurality of tracks 116 may facilitate movement of the drawer body 111 into and/or away from the drive-through window 10. Furthermore, the plurality of tracks 116 may removably connect to another plurality of tracks disposed within the drive-through window 10.

The retraction button 117 may include a retraction motor, but is not limited thereto.

The retraction button 117 may be disposed on at least a portion of the drawer body 111. The retraction button 117 may be depressed to move the drawer body 111 within the drive-through window 10 in response to rotation of the retraction motor. In other words, the drawer body 111 may move within the drive-through window 10 in response to depressing the retraction button 117.

The drawer handle 118 may be disposed on at least a portion of a second end of the drawer body 111. The drawer handle 118 may facilitate gripping thereof. As such, the drawer body 111 may move in response to movement of the drawer handle 118, such as pushing and/or pulling thereof by the user. Accordingly, the drawer handle 118 may facilitate manual manipulation of the drawer body 111 by the owner.

The transaction device 120 may include a main body 121, a display unit 122, a payment receiving section 123, a change dispenser 124, a receipt dispenser 125, an audio unit 126, a plurality of input ports 127, a power source 128, and an access barrier 129, but is not limited thereto.

Referring to FIGS. 1 and 2, the main body 121 is illustrated to have a rectangular prism shape. However, the main body 121 may be rectangular, circular, conical, triangular, pentagonal, hexagonal, heptagonal, octagonal, or any other shape known to one of ordinary skill in the art, but is not limited thereto.

The main body 121 may be disposed within at least a portion of the drive-through window 10 and/or connected to the drawer assembly 110.

The display unit 122 may include a control unit 122a (e.g., a processing unit, such as a processor, a communications unit, such as WIFI, Bluetooth, cellular, near field communications (NFC), Internet, a storage unit, such as hard disk drive, solid state drive, cloud storage), but is not limited thereto.

Furthermore, the display unit 122 may be a plasma screen, an LCD screen, a light emitting diode (LED) screen, an organic LED (OLED) screen, a computer monitor, a hologram output unit, a sound outputting unit, or any other type of device that visually or aurally displays data. Moreover, the display unit 122 may integrate input functions and operate as a touchscreen.

The display unit 122 may be disposed on at least a portion of the main body 121. The display unit may display a menu of food and/or beverage items. Additionally, the display unit 122 may display a price of each of the food and/or beverage items, and a total price of an order. Moreover, the display unit may receive an input of any food and/or beverage items desired by the user.

The control unit 122a may keep track of the food and/or beverage items desired by the user and/or the total price of the order. Additionally, the control unit 122a may control the drawer assembly 110 via a drawer motor. Specifically, the control unit 122a may eject the drawer assembly 110 from the driver-through window 10 in response to receiving a completed order, and/or the drawer body 111 and/or the tray 112 receiving the at least one item 10 thereon.

Furthermore, the control unit 122a may receive input from the owner to control the hydraulic piston 114. Alternatively, the display unit 122 may receive input from the user to control the height of the tray 112 using the hydraulic piston 114.

The payment receiving section 123 may include a card slot 123a, a paper bill slot 123b, a coin slot 123c, and a contactless receiver 123d, but is not limited thereto.

The card slot 123a may be disposed on at least a portion of the main body 121. The card slot 123a may receive a payment card (e.g., credit card and/or a debit card) therein.

The paper bill slot 123b may be disposed on at least a portion of the main body 121. The paper bill slot 123b may receive at least one paper bill (i.e. money) therein.

The coin slot 123c may be disposed on at least a portion of the main body 121. The coin slot 123c may receive at least one coin (i.e. money) therein.

The contactless receiver 123d may be disposed on at least a portion of the main body 121. The contactless receiver 123d may receive an electronic wallet signal thereto. More specifically, the contactless receiver 123d may receive the electronic wallet signal, such as from a software application linked to a monetary account (e.g., a bank account, a credit card account) to pay for the at least one item 10.

The change dispenser 124 may be disposed on at least a portion of the main body 121. The change dispenser 124 may dispense money (i.e. paper bill and/or coin) therefrom. In other words, the change dispenser 124 may dispense a difference in money owed to the user received by the payment receiving section 123, such that the owner may provide change to the user.

The receipt dispenser 125 may include a receipt container 125a, but is not limited thereto.

The receipt dispenser 125 may be disposed on at least a portion of the main body 121. The receipt dispenser 125 may dispense a receipt therefrom. In other words, the receipt dispenser 125 may dispense a statement identifying a list of the food and/or beverage items desired by the user and the total price of the order. Also, the receipt dispenser 125 may dispense a refund receipt in response to the change dispenser 124 dispensing money.

The receipt container 125a may be disposed within at least a portion of the receipt dispenser 125. The receipt container 125a may store the receipt including a receipt roll therein.

The audio unit 126 may include a speaker and a microphone, but is not limited thereto.

The audio unit 126 may be disposed on at least a portion of the main body 121. The audio unit 126 may allow communications between the user, the owner, and/or an employee of the drive-through window 10. As such, the audio unit 126 may emit sounds from the owner and/or the employee to the user, as well as receive sounds from the user to be transmitted to the owner and/or the employee within the drive-through window 10.

Each of the plurality of input ports 127 may include a universal serial bus (USB) port, a cable port, a lightning port, and/or any other port, but is not limited thereto.

The plurality of input ports 127 may be disposed on at least a portion of the main body 121. The plurality of input ports 127 may receive a physical connection (i.e. wired) from at least one external device (e.g., a mobile phone, a tablet computer, and a personal digital assistant (PDA)). Furthermore, the plurality of input ports 127 may send input from the at least one external device to the display unit 122 and/or the control unit 122a. As such, the plurality of input ports 127 may facilitate control of the display unit 122 and/or the control unit 122a, such that the display unit 122 does not need to receive direct input thereon by the user.

The power source 128 may include a power inlet, a battery, and a solar cell, but is not limited thereto.

The power source 128 may send power to the drawer assembly 110, the display unit 122, the control unit 122a, the payment receiving section 123, the change dispenser 124, the receipt dispenser 125, the audio unit 126, and/or the plurality of input ports 127.

The access barrier 129 may be movably disposed on at least a portion of the main body 121. The access barrier 129 may move from closed in a first position to at least partially opened in a second position. Conversely, the access barrier 129 may move from opened in the second position to closed in the first position. As such, the access barrier 129 may facilitate access within the main body 121 in the second position and prevent access within the main body 121 in the first position. Accordingly, the access barrier 129 may allow the owner and/or the employee to deposit change (i.e. money) within the change dispenser 124.

The sanitization device 130 may include an ultraviolet (UV) light and a decontaminant spray (e.g., an alcoholic compound), but is not limited thereto.

The sanitization device 130 may be disposed on at least a portion of the drawer assembly 110 and/or the transaction device 120. The sanitization device 130 may illuminate a UV light and/or spray a decontaminant on the outer surface of the barrier 115 and/or the barrier handle 115a. As such, the sanitization device 130 may decontaminate and/or cleanse the barrier 115 and/or the barrier handle 115 to prevent transmission of a pathogen (e.g., bacteria, virus, fungus, parasite) and/or a disease.

The heating unit 140 may include a heat lamp and a heat pump, but is not limited thereto.

The heating unit 140 may be disposed within at least a portion of the drawer body 111. The heating unit 140 may emit heat from the heat lamp and/or blow hot air from the heat pump within the drawer body 111, such that the heating unit 140 may increase a temperature level within the drawer body 111. As such, the heating unit 140 may keep the at least one item 10 warm and/or hot, such that the at least one item 10 may remain warm and/or hot, and not decrease in temperature.

Therefore, the drive-through transaction system 100 may prevent physical interaction between the user and/or the owner. As such, the drive-through transaction system 100 may expedite transactions at the drive-through window 10.

The present general inventive concept may include a drive-through transaction system 100 disposed within a drive-through window 10, the drive-through transaction system 100 including a drawer assembly 110, including a drawer body 111, a tray 112 movably disposed within at least a portion of the drawer body 111 to receive at least one item 20 thereon, and a plurality of cup holders 113 disposed on and within at least a portion of the tray 112 to receive at least one beverage cup 20 therein, and a transaction device 120 connected to the drawer assembly 110 to receive input of an order and display a price of the order, such that the drawer body 110 is ejected from the drive-through window 10 in response to completion of the order.

The tray 112 may separate a first portion of the drawer body 111 from a second portion of the drawer body 111.

The drawer assembly 110 may further include a hydraulic piston 114 disposed on at least a portion of a base of the drawer body 111 and connected to at least a portion of a bottom surface of the tray 112 to adjust a height of the tray 112.

The drawer assembly 110 may further include a barrier 115 movably disposed on at least a portion of the drawer body 111 to prevent access within the drawer body 111 in a first position and allow access within the drawer body 111 in a second position, and a barrier handle 115a disposed on at least a portion of an outer surface of the barrier 115 to facilitate gripping thereof.

The drive-through transaction system 100 may further include a sanitization device 130 disposed on at least a portion of the drawer assembly 110 and the transaction device 120 to decontaminate the barrier 115 and the barrier handle 115a.

The transaction device 120 may include a main body 121, a display unit 122 disposed on at least a portion of the main body 121 to display the order thereon, a payment receiving section 123 disposed on at least a portion of the main body 121 to receive at least one of a payment card, at least one paper bill, at least one coin, and an electronic wallet signal therein, and a change dispenser 124 disposed on at least a portion of the main body 121 to dispense a difference in money owed as received by the payment receiving section 123.

The drive-through transaction system 100 may further include a heating unit 140 disposed within at least a portion of the drawer body 111 to increase a temperature level within the drawer body 111.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A drive-through transaction system disposed within a drive-through window, the drive-through transaction system comprising:
a drawer assembly, comprising:
a drawer body,
a tray movably disposed within at least a portion of the drawer body to receive at least one item thereon, and
a plurality of cup holders disposed on and within at least a portion of the tray to receive at least one beverage cup therein; and
a transaction device connected to the drawer assembly to receive input of an order and display a price of the order, such that the drawer body is ejected from the drive-through window in response to completion of the order.

2. The drive-through transaction system of claim 1, wherein the tray separates a first portion of the drawer body from a second portion of the drawer body.

3. The drive-through transaction system of claim 1, wherein the drawer assembly further comprises:
a hydraulic piston disposed on at least a portion of a base of the drawer body and connected to at least a portion of a bottom surface of the tray to adjust a height of the tray.

4. The drive-through transaction system of claim 1, wherein the drawer assembly further comprises:
a barrier movably disposed on at least a portion of the drawer body to prevent access within the drawer body in a first position and allow access within the drawer body in a second position; and
a barrier handle disposed on at least a portion of an outer surface of the barrier to facilitate gripping thereof.

5. The drive-through transaction system of claim 4, further comprising:
a sanitization device disposed on at least a portion of the drawer assembly and the transaction device to decontaminate the barrier and the barrier handle.

6. The drive-through transaction system of claim 1, wherein the transaction device comprises:
a main body;
a display unit disposed on at least a portion of the main body to display the order thereon;
a payment receiving section disposed on at least a portion of the main body to receive at least one of a payment card, at least one paper bill, at least one coin, and an electronic wallet signal therein; and
a change dispenser disposed on at least a portion of the main body to dispense a difference in money owed as received by the payment receiving section.

7. The drive-through transaction system of claim 1, further comprising:
a heating unit disposed within at least a portion of the drawer body to increase a temperature level within the drawer body.
